(19) United States
(12) Patent Application Publication
(10) Pub. No.: US 2014/0372973 A1
(43) Pub. Date: Dec. 18, 2014

(54) SYSTEM AND METHODS FOR GENERATING DATA OBJECTS

(71) Applicant: Level 3 Communications, LLC, Broomfield, CO (US)

(72) Inventor: Erik Gwyn Urdang, Boulder, CO (US)

(73) Assignee: Level 3 Communications, LLC

(21) Appl. No.: 13/916,420

(22) Filed: Jun. 12, 2013

(51) Int. Cl. G06F 9/44

(52) U.S. Cl. CPC G06F 8/30
USPC 717/108

(57) ABSTRACT

Aspects of the present disclosure include systems and methods for generating generic data patterns or structures that may be used to generate data-driven objects for subsequent use in software development. In various aspects, data-driven objects may be defined and subsequently used to design the anticipated behavior of a software application.

### TECHNICAL FIELD

Aspects of the present disclosure relate to computer programming paradigms, and more particularly, to methods and systems for generating data-driven objects for use in software development.

### BACKGROUND

Virtually all software today is designed based on an object-oriented programming paradigm that conceptualizes the logic of a software application into self-sustaining concepts known as “objects”. An object is an entity or item that combines data and associated operations commonly referred to as methods that may be used to manipulate the data. Object-oriented programming languages, such as C++, Java, and Python, generate executable software applications by combining objects together into a structured network to form a complete software program. As a result, any software generated from an object-oriented paradigm is implemented in a manner that inextricably links the object operational code and the data on which it acts. Accordingly, in order to make any modifications to the software, developers must redesign or otherwise modify significant portions of both the code and the data representation, and subsequently recompile the modified code to generate new executable applications, all of which may be time consuming, labor intensive, and expensive.

In contrast, a data-driven programming is another type of programming paradigm in which data is processed by code using standardized techniques. When employing a data-driven programming paradigm, operational code is distinguished from the data structures on which it acts. Further, both the operational code and the data structures are implemented so that developers can make changes to the logic of the program by only editing the data structure.

It may be desirable to have a mechanism with appropriate architectural support that enables the generation of object-oriented type objects in accordance with a data-driven programming paradigm for use in the development of software applications. It is with these concepts in mind, among others, that various aspects of the present disclosure were conceived.

### SUMMARY

One aspect of the present disclosure involves systems for defining generic data objects. The system includes at least one processor configured to define one or more generic objects in a standard data format and generate an application implemented based on the one or more generic objects. The at least one processor is further configured to update the one or more generic objects by modifying a data representation corresponding to at least one of the one or more generic objects, thereby changing the functionality of the application without generating a new version of the application.

Aspects of the present disclosure include methods for defining generic data objects. The method is executable by at least one processor. The method includes defining one or more generic objects in a standard data format. The method also includes generating an application implemented based on the one or more generic objects. The method includes updating the one or more generic objects in the standard data format by modifying a data representation corresponding to at least one of the one or more generic objects, thereby changing the functionality of the application without generating a new version of the application.

Aspects of the present disclosure include non-transitory computer-readable mediums encoded with instructions for defining generic data objects. The instructions executable by a processor defining one or more generic objects in a standard data format. The methods include generating an application implemented based on the one or more generic objects. The methods include updating the one or more generic objects in the standard data format by manipulating an aspect of an object representation corresponding to at least one of the one or more generic objects, thereby changing the functionality of the application without generating a new version of the application.

### BRIEF DESCRIPTION OF THE FIGURES

Aspects of the present disclosure may be better understood and its numerous objects, features, and advantages made apparent to those skilled in the art by referencing the accompanying drawings. It should be understood that these drawings depict only typical embodiments of the present disclosure and, therefore, are not to be considered limiting in scope.

FIG. 1 is a flow chart illustrating a method for generating objects, in accordance with one aspect of the present disclosure.

FIG. 2 is block diagram of a computing environment for generating objects, in accordance with one aspect of the present disclosure.

FIGS. 3A-3B are block diagrams illustrating objects, in accordance with aspects of the present disclosure.

FIG. 3C is an example illustration of objects, in accordance with aspects of the present disclosure.

FIGS. 4A-4B are illustrations of user interfaces, in accordance with one aspect of the present disclosure.

FIG. 5 is a block diagram of a processing device, in accordance with one aspect of the present disclosure.

### DETAILED DESCRIPTION

Aspects of the present disclosure include systems and methods for generating generic data patterns or structures that may be used to generate data-driven objects for subsequent use in software development. In various aspects, objects, as understood in the context of an object-oriented programming paradigm, may be defined or redefined as one or more data-driven objects, such as a domain object and a corresponding attribute object, both of which may be used to design the anticipated behavior of a software application. Subsequently, any modifications, updates, or changes made to the data-driven objects used to define the behavior of the application will automatically be represented within the execution of the application, without having to make any modifications to the logical aspects of the application, such as to the application's functions or routines, and further, without having to generate new executable code corresponding to the application, such as for example, by engaging in compilation procedures.

The Object-oriented programming paradigm defines a set of interacting objects for the purpose of solving a software problem. Each individual object contains encapsulated data fields that can store data (attributes that describe the object) and corresponding methods or procedures for interacting with the data. For example, such object methods may include checks and safeguards that are specific to the types of data the object contains. An object can also offer simple-to-use, standardized methods for performing particular operations on its data, while concealing the specifics of how those tasks are accomplished. Thus, objects can be thought of as wrapping data within a set of functions designed to ensure that the data is used appropriately and to assist in that use. Objects are generally implemented to interact with other objects, and are combined to design complete computer programs. Accordingly, an object-oriented software program may be viewed as a collection of interacting objects.

Object-oriented programs generally contain different types of objects, each type corresponding to a particular individual, identifiable item, unit, or entity, either real or abstract. For example, an object may correspond to an abstract concept, such as a specific kind of complex data to be managed, or alternatively, to a real-world object such as a bank account or a bicycle. Moreover, such an object-oriented program might contain multiple copies of each type of object, one for each of the real-world objects the program is dealing with. For example, one could imagine a software application including one bank account object for each real-world account at a particular bank. Each copy of the bank account object would be identical in the methods it offers for manipulating or reading its corresponding data, but the data inside each object would differ reflecting the different history of each account.

Although object-oriented programming has become ubiquitous, the use of such a software paradigm may present many challenges. In particular, when an application developer decides to update a particular object of a given software application, such as, for example, making a modification to the object's data representation (i.e., adding and/or removing data fields), any other objects within the software application that are currently interacting with the particular object may fail, if the modified version of the particular object is incompatible with the other objects. Such a problem can occur when, for example, the developer of the other objects is unable to anticipate the data representation changes that the developer of the particular object is currently implementing, or may implement in the future. Thus, any changes to object-oriented programs may require continuous redevelopment of multiple objects within a given software program, and frequent regeneration of executable versions of the software application (i.e. recompilation due to the modifications made to objects and logical code), as the representation of data is often inextricably linked to the logical aspects of the program. Stated differently, a change to the data representation (i.e., the data fields) of an object within a software application may require developers to redesign and recompile the logical portions of the software application.

Aspects of the present disclosure enable developers the ability to successfully modify the representation of data within an object without having to change the logical implementation of the software application to which the data pertains. By employing data-driven programming techniques, and in particular, by generating data-driven objects that effectively decouple the data of a object from its logical components (e.g. methods), developers can continuously modify, update, or otherwise extend an application by only changing the data representation of objects, all of which may be automatically recognizable by the logical aspects of the application.

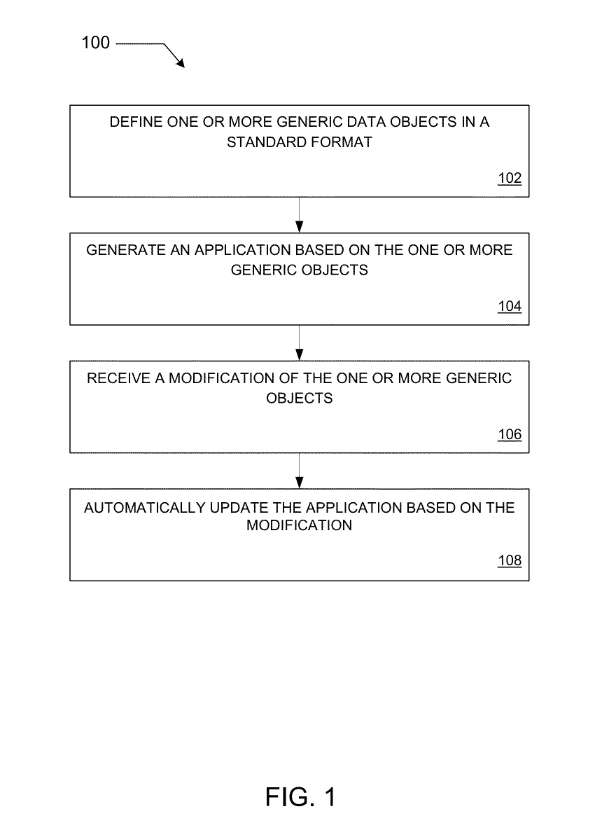

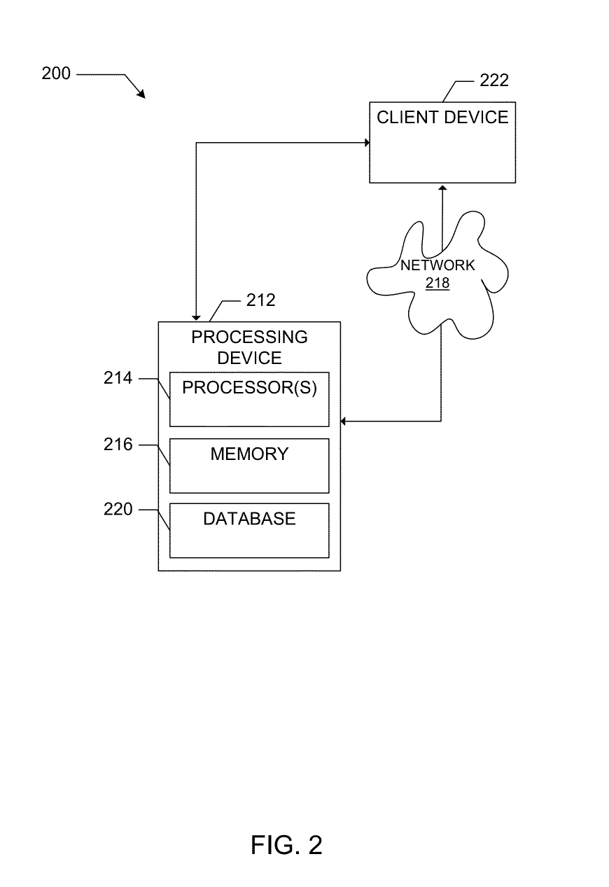

An illustrative method and/or process for generating data-driven objects is depicted in FIGS. 1-2. In particular, FIG. 1 illustrates an example method 100 for generating data-driven objects, and FIG. 2 illustrates a computing environment 200 including various hardware systems and/software components that may be used to execute the method 100.

As illustrated in FIG. 1, method 100 begins defining one or more generic data-driven objects in a standard format (operation 102). As described above, an object is a unique item or entity that may contain data and corresponding operations. A data-driven object includes a representation of data only. In one embodiment, two specific types of generic, data-driven objects may be generated: a “domain” object and an “attribute” object. The domain object may include a data representation in the form of a list of attributes that describe various characteristics of the particular domain data object. Domain object attributes may be analogized with real-world objects. In particular, real-world objects share a set of attributes. Consider a real-world object, such as a dog. Dogs have a set of attributes—name, color, breed, etc. As another example, cars have a set of attributes—name, transmission type, color, style, etc. The generated generic data-driven objects are conceptually similar to such real-world objects, as they too may consist of a set of attributes. Each generic data-driven object stores its set of attributes in one or more data fields. The data contained within a data field may be a value such as a number (i.e., integers, doubles, and the like) and/or strings of characters, or some other “type” of data value, as is generally known to one of ordinary skill in the art.

The attribute object may correspond to one of the attributes listed within the generated domain object, and may include a data representation in the form of one or more data fields, such as a name data field, a value data field, a type data field, among others. For example, referring to the dog example, the attribute “breed” may correspond to an attribute object including a name data field containing a specific name for the breed of dog, a value data field, a type data field, etc.

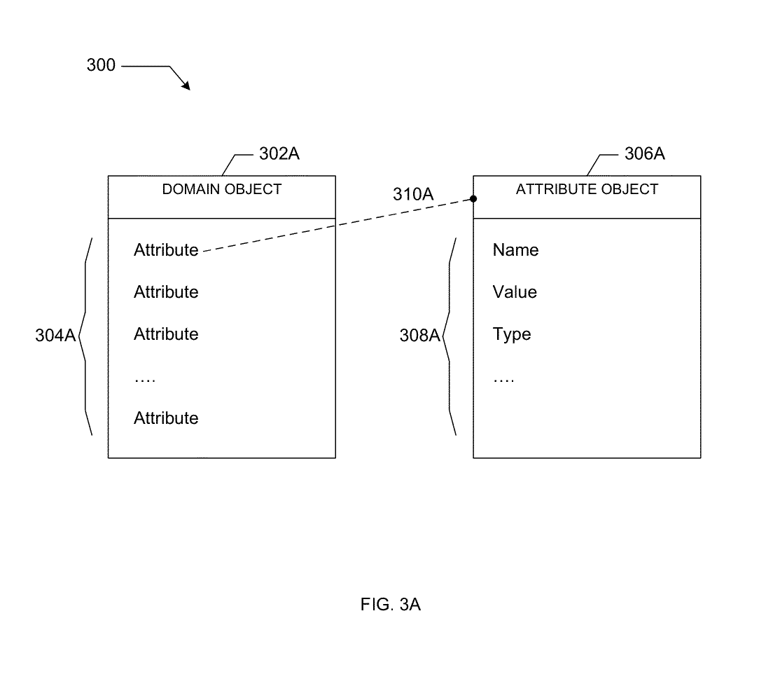

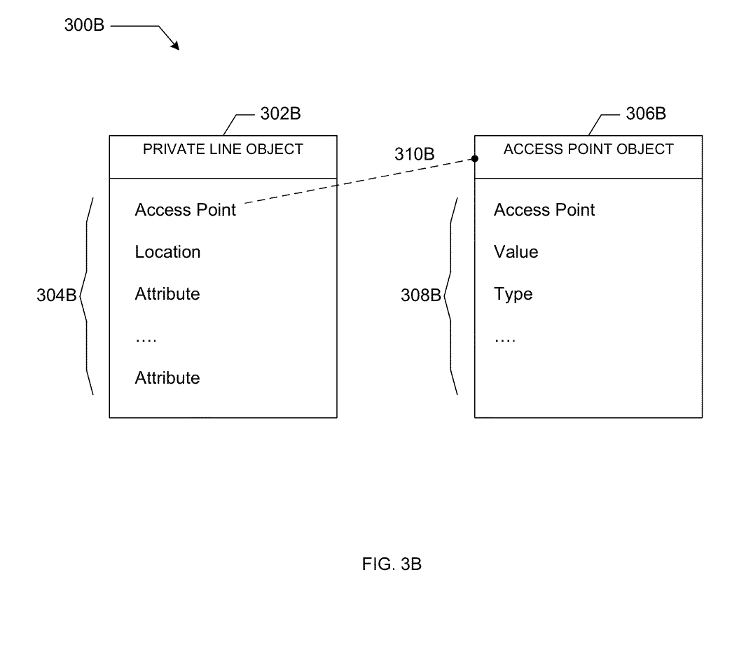

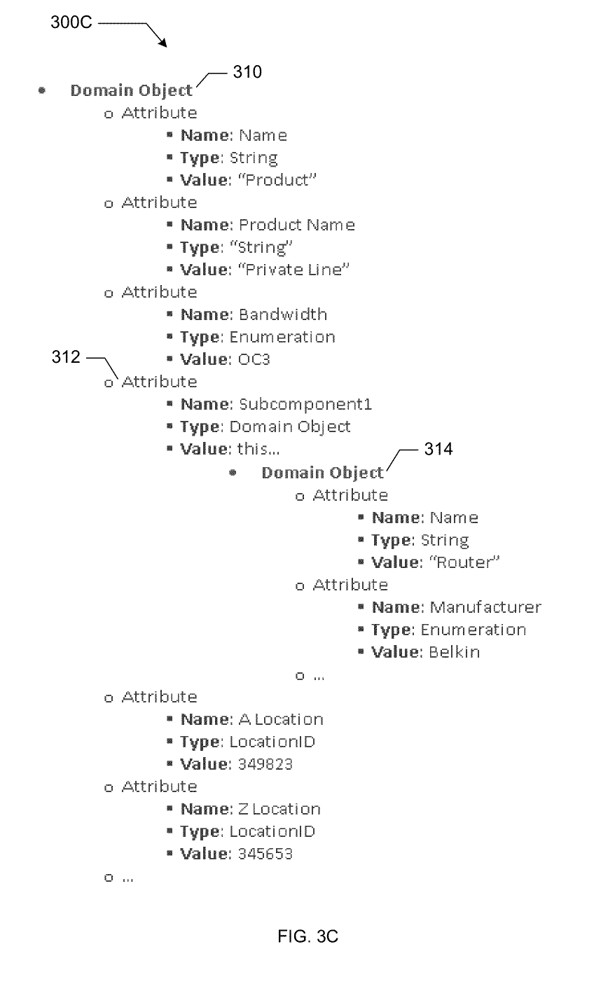

FIG. 3A is an example illustration of a domain object 302A and an attribute object 306A. As illustrated, the domain object 302A includes a list of attributes 304A, and the attribute object 306A includes one or more data fields 308A (e.g., a name data field, value data field, and type data field). The attribute object 306A, in one embodiment, may be referenced by and/or included within the list of attributes 304A of the domain object 302A, effectively linking such objects, as illustrated by 310A.

FIG. 3B is an illustration of the domain object 302B and the attribute object 306B in the context of a telecommunication service provider offering products to customers. More particularly, assume a telecommunication service provider is capable of offering a variety of products to customers. For example, the telecommunication service provider may provide internet services, content delivery products, private line services, rural access solutions, wavelength services, virtual private network services, and the like. In order to offer such products, assume the telecommunication service provider has developed a variety of software applications and/or programs, all of which may be implemented using generic, data-driven objects corresponding to each product being offered.

As illustrated in FIG. 3B, the domain object 302B corresponds to a private line internet access product being offered by a telecommunication service provider to customers that is accessible through one of the software applications developed by the telecommunication service provider. Thus, as illustrated, the domain object 302B is an object corresponding to a private line product that includes an access point attribute that describes how the private line may be accessed, and a location attribute that identifies the specific location at which the private line may be accessed, among other attributes. Further, in the illustrated example, the attribute object 306B corresponds to an access component and is included as an attribute within the private line object 302B attribute list 304B, as indicated by 310B. The access point object 306B includes one or more data fields 308B (e.g., a name data field, value data field, and type data field). FIG. 3C provides yet another example illustration of the generation of domain objects and attributes, according to one embodiment. As illustrated, Domain Object 1 310 includes six attribute objects, one of which is attribute object Subcomponent1 312. The Subcomponent1 312 includes reference to a Domain Object 314. Thus, a domain object may have any number of attribute objects and an attribute may in turn reference or otherwise include a domain object.

Any generated generic data-driven data objects may be implemented in a standard data format, such as according to an extensible markup language (“XML”), which is a particular type of markup language defining a set of rules for encoding documents in a machine-readable format. Typically, XML documents form a tree structure that starts at a “root/parent” element and branches to one or more “child” elements. Accordingly, the domain object and attribute object may be defined according to such XML standards, as are understood by one of ordinary skill in the art. Although the domain objects and attribute objects have been described as being implemented in accordance with XML standards, such an implementation is not intended to be limiting in any way. Rather, it is contemplated that other types of data formats may be implemented, some of which include JavaScript object notation (“JSON”), ordered graph data language (“OGDL”), comma-separated values (“CSV”), and yet another markup language (“YAML”), among others.

As illustrated in FIG. 2, the data-driven objects may be generated by a processing device 212, which may be a work station, server, mobile device, mobile phone, processor, and/or other type of processing device. The processing device may include one or more processors 214 that process software or other machine-readable instructions and may include a memory 216 to store the software or other machine-readable instructions and data. The processing device 212 may include a communication system (not shown) to communicate via a wireline and/or wireless communications through a communications network 218 such as through the Internet, an intranet, an Ethernet network, a wireline network, a wireless network and/or another communication network. The processing device 212 may include a database 220, which is a general repository of data including object data, object code, source code, applications, and/or any other data related to generating generic data-driven objects. The database 220 may include memory and one or more processors or processing systems to receive, process, query, and transmit communications and store and retrieve such data. In another aspect, the data may be a database server.

Referring again to FIG. 1, once one or more generic data-driven objects have been generated, an application may be generated that is also data-driven, or driven by the one or more data-driven generic objects (operation 104). More particularly, a user, such as a developer, may provide input, such as source code, that is implemented based upon or otherwise in conjunction with the generated data-driven objects.

A user may access a client device 222 to interact with the generated interfaces and provide input and/or receive output, such as the source code described above. The client device 222 may be a personal computer, work station, server, mobile device, mobile phone, tablet device, processor, and/or other processing device capable of implementing and/or executing server processes, software, applications, etc. Additionally, the client device 222 may include one or more processors that process software or other machine-readable instructions and may include a memory to store the software or other machine-readable instructions and data. The client device 222 may also include a communication system to communicate with the various components of the processing device 212 via a wireline and/or wireless communications, such as through a network 218, such as the Internet, an intranet, an Ethernet network, a wireline network, a wireless network, a mobile communications network, and/or another communication network.

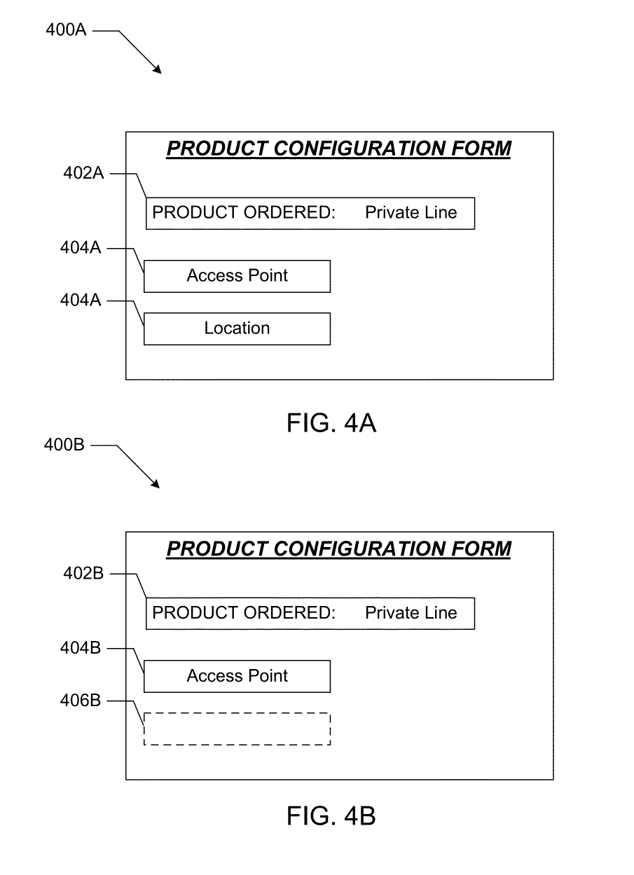

Any software generated from the source code, which may be any type of software application, applet, program, source code, and the like, may process, analyze, and/or otherwise access the generated data-driven objects. The source code may include, for example, functions, routines, or processes that access, interpret, and manipulate any generated generic data-driven objects. In one particular embodiment, the generated application may be a graphical user-interface including various interactive elements, such as buttons, forms, fields, selections, inputs, streams, etc., that are data-driven by the generic data objects generated by the processing device 212. FIGS. 4A-4B illustrate examples of graphical user-interfaces generated by the processing device 212, based on the generated data-driven objects of FIG. 3. Accordingly, as shown in FIG. 4A, a user-interface for ordering a private line product from a telecommunication service provider is shown. The user-interface was implemented to display a private line product 402A, from the private line object 302B. The interface further includes the display of an access point 404A and a location 404B, both of which were included in the attribute list of the private line object 302B.

Often, changes, updates, modifications, etc. may be made to data-driven objects that have been previously defined. For example, a developer may make one or more changes to various aspects of a data object for a variety reasons. For example, referring to the telecommunication service provider example above, the provider may want to modify a product, such as the private line product currently being offered to customers. In particular, the provider may want to modify the definition of the product as originally defined within the data-driven object. Thus, referring again to FIG. 1, a modification to a generic data-driven object may be received (operation 106). In one embodiment, the received modification may include the removal and/or addition of an attribute of an data-driven object. In another embodiment, the modification may include the generation of a new data-driven object. It is contemplated that any type of modification articulating a specific combination of data-driven objects, and/or attributes corresponding to a specific data-driven object, may be received as a modification.

In response to the received modification, the various interfaces generated to enable customers to order products may be automatically modified to display the data contained within the data-driven objects (operation 108). Stated differently, the generated user-interfaces may be dynamically data-driven by any modifications received by the processing device 212. The dynamic behavior occurs within the data contained within the data-driven objects. Thus, when a modification to a data-driven object is received, any software, such as a generated user-interface presenting or otherwise consuming the data object, will automatically be updated and/or comply with the modification.

FIG. 4B provides an example illustration of a modification received by the processing device 212, when compared to FIG. 4A. For example, referring to the private line product described above, assume a modification may be received by the processing device 212 indicating that the private line object 302B no longer requires the definition of a specific location. Thus, a developer modifies the private line object 302B and removes a “location” as an attribute of the private line object 302B. In response, the device currently displaying the user-interface 400A may automatically update the interface to indicate that a location attribute corresponding to the private line product is no longer configurable or available, as illustrated in the user-interface 400B at 406B. Such changes were made without modifying the actual functional processes and routines of the interface, but rather modifications to the private line data object 302B.

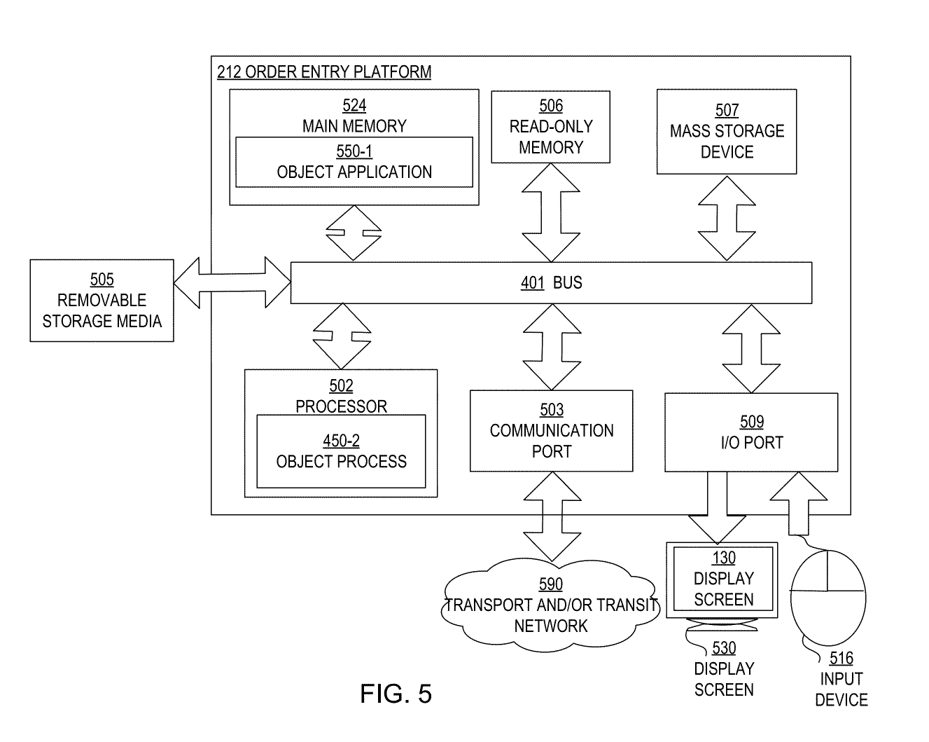

FIG. 5 is an example schematic diagram of the processing device 212 that may be used to generate generic data-driven objects, according to one embodiment. The processing device 212 includes a bus 501 (i.e., interconnect), at least one processor 502, at least one communication port 503, a main memory 504, a removable storage media 505, a read-only memory 506, and a mass storage device 507. Processor(s) 502 can be any known processor, such as, but not limited to, an Intel® Itanium® or Itanium 2® processor(s), AMD® Opteron® or Athlon MP® processor(s), or Motorola® lines of processors. Communication port 503 can be any of an RS-232 port for use with a modem-based dial-up connection, a 10/100 Ethernet port, a Gigabit port using copper or fiber, or a USB port. Communication port(s) 503 may be chosen depending on a network such as a Local Area Network (LAN), a Wide Area Network (WAN), or any network to which the computer system 100 connects. The order entry platform 212 may be in communication with peripheral devices (e.g., display screen 530, input device 516 via Input/Output (I/O) port 509.

Main memory 504 can be Random Access Memory (RAM) or any other dynamic storage device(s) commonly known in the art. Read-only memory 506 can be any static storage device(s) such as Programmable Read-Only Memory (PROM) chips for storing static information such as instructions for processor 502. Mass storage device 507 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices, may be used.

Bus 501 communicatively couples processor(s) 502 with the other memory, storage and communications blocks. Bus 501 can be a PCI/PCI-X, SCSI, or Universal Serial Bus (USB) based system bus (or other) depending on the storage devices used. Removable storage media 505 can be any kind of external hard drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), etc.

Embodiments herein may be provided as a computer program product, which may include a machine-readable medium having stored thereon instructions which may be used to program a computer (or other electronic devices) to perform a process. The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

As shown, main memory 504 is encoded with object application 550-1 that supports functionality as discussed above and as discussed further below. For example, in one embodiment, the object application 550-1 may include or otherwise implement the various processes and/or instructions described herein. Object application 550-1 (and/or other resources as described herein) can be embodied as software code such as data and/or logic instructions (e.g., code stored in the memory or on another computer-readable medium such as a disk) that supports processing functionality according to different embodiments described herein. During operation of one embodiment, processor(s) 502 accesses main memory 504 via the use of bus 501 in order to launch, run, execute, interpret, or otherwise perform the logic instructions of the object application 550-1. Execution of object application 550-1 produces processing functionality in object process 550-2. In other words, the object process 550-2 represents one or more portions of the object application 550-1 performing within or upon the processor(s) 502 in the computer system 500.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system comprising:
at least one processor to:
define one or more generic objects in a standard data format;
generate an application implemented based on the one or more generic objects; and
update the one or more generic objects by modifying a data representation corresponding to at least one of the one or more generic objects, thereby changing the functionality of the application without generating a new version of the application.

2. The system of claim 1, wherein the one or more generic objects includes a domain object and an attribute object, wherein the data representation corresponds to the domain object and wherein the data representation includes a list of attributes.

3. The system of claim 2, wherein the application is an interface capable of interpreting the list of attributes of the domain object.

4. The system of claim 2, wherein updating an aspect of an object representation comprises adding or removing an attribute to or from the list of attributes of the domain object.

5. The system of claim 1, wherein without generating a new version comprises without recompiling the application to generate a new executable.

6. The system of claim 1, wherein defining one or more objects in a standard data format comprises defining the one or more objects in an extensible markup language (“XML”) format.

7. A method for generating data objects comprising:
defining one or more generic objects in a standard data format;
generating an application implemented based on the one or more generic objects; and
updating the one or more generic objects in the standard data format by modifying a data representation corresponding to at least one of the one or more generic objects, thereby changing the functionality of the application without generating a new version of the application.

8. The method of claim 7, wherein the one or more generic objects includes a domain object and an attribute object, wherein the data representation corresponds to the domain object and wherein the data representation includes a list of attributes.

9. The method of claim 8, wherein the application is an interface capable of interpreting the list of attributes of the domain object.

10. The method of claim 8, wherein updating an aspect of an object representation comprises adding or removing an attribute to or from the list of attributes of the domain object.

11. The method of claim 7, wherein without generating a new version comprises without recompiling the application to generate a new executable.

12. The method of claim 7, wherein defining one or more objects in a standard data format comprises defining the one or more objects in an extensible markup language (“XML”) format.

13. A non-transitory computer-readable medium encoded with instructions for defining generic data objects, the instructions executable by a processor, comprising:
defining one or more generic objects in a standard data format;
generating an application implemented based on the one or more generic objects; and
updating the one or more generic objects in the standard data format by manipulating an aspect of an object representation corresponding to at least one of the one or more generic objects, thereby changing the functionality of the application without generating a new version of the application.

14. The non-transitory computer readable medium of claim 13, wherein the one or more generic objects includes a domain object and an attribute object, wherein the data representation corresponds to the domain object and wherein the data representation includes a list of attributes.

15. The non-transitory computer readable medium of claim 14, wherein the application is an interface capable of interpreting the list of attributes of the domain object.

16. The non-transitory computer readable medium of claim 14, wherein updating an aspect of an object representation comprises adding or removing an attribute to or from the list of attributes of the domain object.

17. The non-transitory computer readable medium of claim 13, wherein without generating a new version comprises without recompiling the application to generate a new executable.

18. The non-transitory computer readable medium of claim 13, wherein defining one or more objects in a standard data format comprises defining the one or more objects in an extensible markup language (“XML”) format.
